(19) United States
(12) Patent Application Publication
(10) Pub. No.: US 2007/0188399 A1
(43) Pub. Date: Aug. 16, 2007

(54) Dipole antenna

(75) Inventor: Marc Rickenbrock, Halver (DE)

Correspondence Address: K.F. ROSS P.C., 5683 RIVERDALE AVENUE, SUITE 203 BOX 900, BRONX, NY, 10471-0900, US

(73) Assignee: LUMBERG CONNECT GMBH & CO KG

(21) Appl. No.: 11/704,157

(22) Filed: Feb. 8, 2007

(30) Foreign Application Priority Data
Feb. 10, 2006 (DE) 102006006144.6

(51) Int. Cl. H01Q 9/26

(52) U.S. Cl. 343/803

(57) ABSTRACT

A conductor for use as a radiator in an antenna has a contact section adapted to connect to a high-frequency source, a first section of alternating shape extending along a first longitudinal axis from an inner end at the contact section to an outer end, and a second section of alternating shape extending along a second longitudinal axis generally coplanar with and parallel to the first axis from the first-section outer end toward the contact section. It can also have a third section of alternating shape extending along a third longitudinal axis generally coplanar with and parallel to the first and second axes from the contact section and having an outer end flanked by the first and second sections.

### FIELD OF THE INVENTION

The present invention relates to an antenna. More particularly this invention concerns conductive radiator for a dipole antenna.

### BACKGROUND OF THE INVENTION

An-electrical conductor for a radiator of a monopole or dipole antenna has a input contact for an HF source, and in order to make the antenna as short as possible, measured longitudinally, is bent back at least once, and thus has at least two conductor sections that have one longitudinal axis each and that preferably are separated at a distance in parallel alignment, and at a first conductor section extend longitudinally away from the contact region, and that at a second bent-back conductor section extends approximately longitudinally back toward the contact region, the longitudinal axes of the first and second-conductor sections defining a conductor plane, and the first conductor section having an alternating, or zig-zag shape along its length.

Such electrical conductors are known from the prior art as components of antennas, in particular dipole antennas. For dipole antennas, two electrical conductors that extend longitudinally away for the transmission and reception operation. The length of the electrical conductors that form the two poles of the dipole depends on the particular resonant frequency or the frequency band in which the dipole antenna is to be operated. Each of the conductors has a length of λ/4, so that the dipole antenna has an overall length of λ/2. In particular for lower resonant frequencies, a dipole antenna therefore has a comparatively large length.

One possibility for reducing the space requirements lies in bending back the arms that are formed by the electrical conductors. This is known from U.S. Pat. No. 3,229,298, from GB 2 404 497, and from WO 2005/076407. Such a bent-back dipole may be satisfactorily adapted to the, necessary impedance conditions, and operates with reduced space requirements at a high antenna efficiency. Because of these advantages, this structure is preferably used as a base structure for many antennas.

High demands are placed on the-transmission and/or reception performance of antennas, particularly in the field of mobile telecommunication. In addition, there is an ever-increasing need for antennas that operate in multiple frequency bands, i.e. that operate at different resonant frequencies in transmission mode as well as in reception mode.

At the same time, communication devices such as mobile telephones are being equipped with additional functions and components, for example cameras and larger displays, while being further reduced in size, resulting in an increasingly smaller installation space for multiband antennas.

Also in the field of external antennas for communication devices there is a demand for reducing the size, for example in windshield antennas for operating mobile telephones in vehicles. Another field of application for external antennas is data cards that for portable computers provide a wireless connection to mobile communication networks, and thus to the internet. Last, it is becoming increasingly common to install base stations for providing small radio cells (picocells), for example in buildings, to ensure the operation of wireless devices, even inside shielded buildings, or to guarantee adequate wireless access in locations with a high communication volume, such as airports. These applications all require the smallest possible and in particular least conspicuous multifrequency band antennas to ensure wireless access.

### OBJECTS OF THE INVENTION

It is therefore an object of the present invention to provide an improved radiator conductor for an antenna.

Another object is the provision of such an improved radiator conductor for an antenna that overcomes the above-given disadvantages, in particular that is quite short (measured longitudinally) and usable as a single- or multi-band antenna, in particular in a mobile communication, e.g. cell phone, setting.

### SUMMARY OF THE INVENTION

A conductor for use as a radiator in an antenna has a contact section adapted to connect to a high-frequency source, a first section of alternating shape extending along a first longitudinal axis from an inner end at the contact section to an outer end, and a second section of alternating shape extending along a second longitudinal axis generally coplanar with and parallel to the first axis from the first-section outer end toward the contact section. It can also have a third section of alternating shape extending along a third longitudinal axis generally coplanar with and parallel to the first and second axes from the contact section and having an outer end flanked by the first and second sections.

By means of the alternating shape of least two conductor sections, for example a corresponding bending, use may be made of the above-referenced advantages, such as a bent-back dipole antenna, with significant shortening of the length of the electrical conductor in an advantageous manner for reducing the size of the antenna. Likewise, the electrical conductor according to the invention may function as a monopole above a base plate, with the longitudinal axes vertical. It is thus possible to manufacture significantly smaller efficient antennas by use of the electrical conductor according to the invention.

The two conductor sections are preferably held parallel by a bridge section situated in a bight region at outer ends of the first and second sections.

It is preferred that at least one conductor section extends in at least two dimensions in an alternating manner in the plane of the conductor. The conductor section may, for example, have a zigzag shape that alternates about the longitudinal axis, or that meanders about the longitudinal axis. It is also possible to provide at least one conductor section with a shape that alternates in three dimensions about the longitudinal axis of the conductor section, that is having subsections crossing the plane.

Depending on the type of antenna, the electrical conductor may be designed as a printed conductor on a dielectric material, in effect being made as a printed circuit, or may represent an essentially freestanding conductor. In particular, “freestanding” means that the conductor is not mounted on a substrate, and to a lesser extent, that the conductor when anchored at one end can stand on its own and even withstand some transverse forces.

In one particularly preferred embodiment, the electrical conductor according to the invention is designed as a stamped part, in particular as a foil or flat metal sheet, which greatly simplifies the manufacture of such an antenna. A conductor produced as a stamped part and having a zig-zag or meander shape, at least in places, may also be provided with a shape that alternates in three dimensions in a particularly simple manner by alternatingly bending the conductor at an angle with respect to a plane of the stamped part. This allows at least one conductor section to be bent in a zigzag shape-along its length.

In addition to a shortening of the length, the electrical conductor according to the invention may be further reduced in size by providing the bridge section, situated in the bight region of the first and second conductor sections, with a zig-zag or meander shape along its length.

Proceeding from the same problem definition, a further object of the invention is to provide a single- or multiband dipole antenna that is as compact as possible.

The object is achieved by a dipole antenna having the having elements formed by two of the above-described conductors. Particularly preferred is an embodiment with electrical conductors having a mirror-symmetrical shape with respect to one another, each having a first and a second conductor section with a shape that alternates about the respective longitudinal axis.

Such a dipole antenna is characterized by a very small size and good transmission and/or reception characteristics.

In a further important embodiment, the dipole antenna is a multiband dipole antenna, that is for transmitting and receiving in at least one additional frequency band and having at least one additional radiator that is tuned to another frequency band and that includes two electrical conductors that each form a pole of the dipole and that each have a contact region associated with a center of the radiator, the conductors for the additional radiator being positioned in the respective conductor plane defined by the conductors for the first radiator.

The conductor plane is a purely geometric plane in which the electrical conductors may be compactly positioned. The various radiators are interleaved, in a manner of speaking. The electrical conductors for additional radiators may likewise be shaped as described above.

It is also advantageous when, for a multiband dipole antenna having multiple radiators, the electrical conductors for the radiator having the lower resonant frequency define the conductor plane for the electrical conductors for the radiator having the higher resonant frequency.

A multiband dipole antenna may be further reduced in size when two radiators together form an additional radiator by means of capacitive and/or inductive coupling.

The transmission and/or reception characteristics of a multiband dipole antenna may be further improved and the manufacturing expense and effort further reduced when the respective contact regions of the conductors for the radiators positioned in the same conductor plane are converge in a V toward one another in the direction of the center of the radiator, and are joined to a common contact in the center of the radiator.

In particular for a dipole antenna for a base station, a radiator may be provided with a reflector for regulating the transmission and/or reception performance.

The conductor of this invention can, of course, be made as a compact monopole antenna. Such an antenna extends up from a base plate, that is with its longitudinal axes upright.

### BRIEF DESCRIPTION OF THE DRAWING

The above and other objects, features, and advantages will become more readily apparent from the following description, reference being made to the accompanying drawing in which:

FIG. 1 is a schematic diagram of a dipole antenna according to the invention connected to a high-frequency source;

FIGS. 2, 3, 4, 5, and 6 are schematic views of different antennas in accordance with the invention; and

FIG. 7 is a graph showing usable frequency bands for a multiband dipole antenna according to FIG. 6.

### SPECIFIC DESCRIPTION

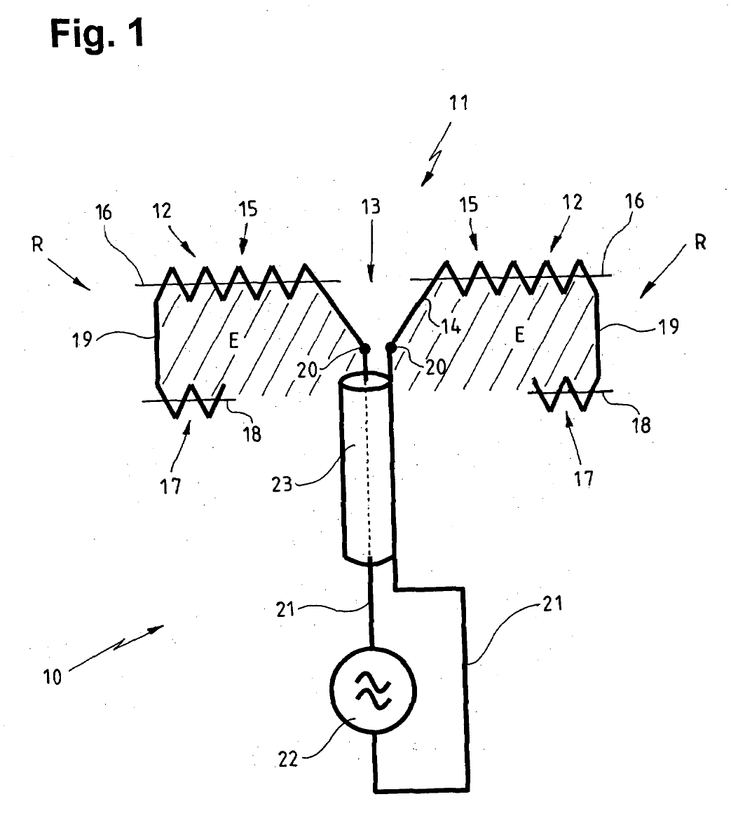

In all FIGS. 1-6 a dipole antenna is shown at 10, although the inventive conductor would also work in another type of antenna. FIG. 1 shows a schematic diagram of a first embodiment of the dipole antenna 10 according to the invention. The dipole antenna 10 has a radiator 11 formed from two electrical conductors 12. Each conductor 12 for the radiator forms a respective pole of the dipole antenna 10.

The electrical conductors 12 have a mirror-symmetrical shape with respect to one another, and are bent back in an approximate U-shape at a bight region R as known in the prior art, thereby shortening the respective conductor 12 in its length.

The illustrated embodiment involves a freestanding conductor 12, and, consequently, a freestanding radiator 11. The term “freestanding” means that the conductors 12 are not laminated to or mounted on a dielectric substrate material, in particular in the form of a printed conductor. Instead, the conductors 12, i.e. the radiator 11, are can be mounted in a freestanding manner essentially by virtue of the rigidity of the conductor material, such as a wire or stamped part of a metal sheet. Depending on requirements of shape, the conductors may be partially supported by means (not illustrated) in order to stabilize them. Such bare conductors 12 are preferred according to the invention since their transmission and/or reception performance is not influenced-by a coating or support material.

Each conductor 12 has a first conductor section 15 having a contact region 14 extending to a center 13 of the radiator 11. The first conductor section 15 extends longitudinally away from the center 13 of the contact region 14 of the radiator and from the outer end at contacts 20 out along a longitudinal axis 16 of the-first conductor section. It is then bent back at its end remote from the contact region 14 to form a second conductor section 17 of the conductor 12 that extends backward along its parallel longitudinal axis 18 toward the center 13 of the radiator 11.

In the bight region R of the conductor 12 the conductor sections 15 and 18 are spaced a transverse distance from another but are interconnected at their ends remote from the center 13 by a common bridge section 19, and in the present case are aligned parallel and at a transverse spacing from one another by means of the common bridge section 19. The sections 15, 17, and 19 are of unitary construction from the same wire, bar, or sheet stock. In addition to the known bight region R, each conductor 12 is further shortened by providing the first and second conductor sections 15 and 17 with an alternating—zig-zag or square meander—shape about their respective longitudinal axes 16 and 18. In FIG. 1, the schematically illustrated conductor 12 has first and second section 15 or 17 that are shaped to zigzag symmetrically across their respective longitudinal axes 16 and 18, while the connection section 19 is flat and extends perpendicular to the axes 16 and 18. At no points do the sections 15 and 17 extend parallel to their axes 16 and 18.

It is also possible for the-second conductor section 17 not to have-an alternating shape along its length 18 if at least one length of the first conductor section 15 having a zig-zag or meander shape corresponds to the length of a second conductor section that is bent back but not alternating in shape.

FIG. 1 also shows by way of example one option for connecting the antenna to an HF source. The respective contact regions 14 of the conductors 12 each have a contact 20 in the center 13 of the radiator via which the conductors 12 that form the dipole are supplied with HF energy from an HF source 22 by means of suitable coaxial cable 21. The supply lines 21 are provided in a region that usually is on an antenna shaft, by a suitable coaxial cable or by a mechanical simulation of a coaxial shape, as represented by reference numeral 23.

Last, FIG. 1 shows that each electrical conductor 12 that forms a pole of the dipole lies in a conductor plane E. For clarity it is noted here that the respective conductor plane E is only a geometric plane and is not a component of the antenna. In FIG. 1 it corresponds to the plane of the view.

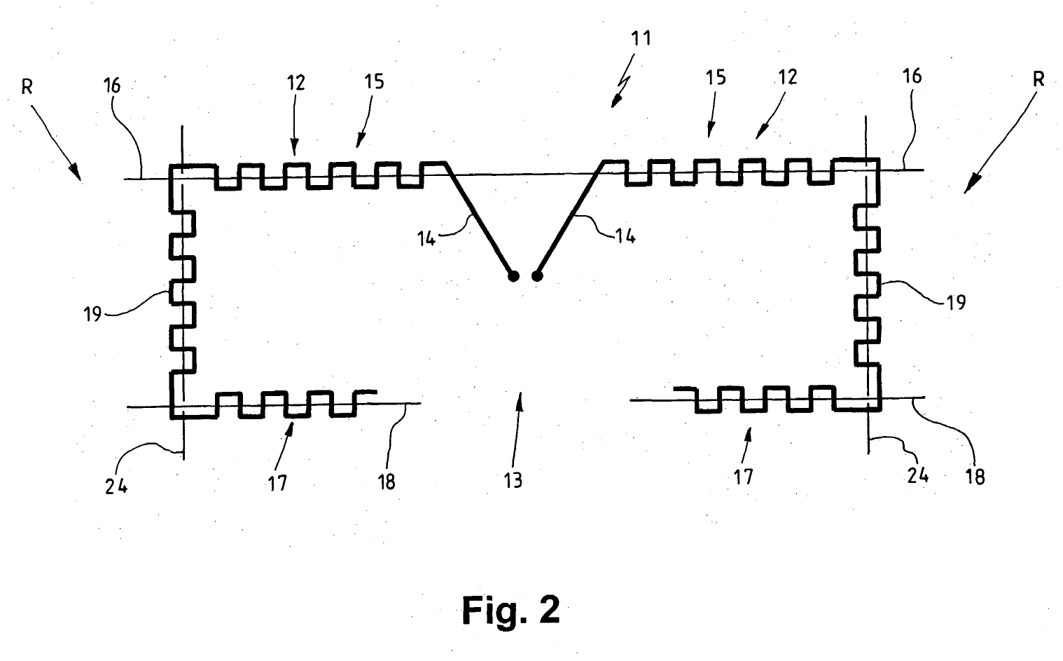

FIG. 2 illustrates only the conductors 12 for the radiator 11 of the dipole antenna 10 in a second embodiment. Here as well, starting from their contact regions 14 the first conductor sections 15 initially extend longitudinally away until the conductor 12 is bent back and shortened in the bight region R, and the second conductor sections 17 extend longitudinally back toward the center 13 of the radiator.

In contrast to FIG. 1, not only do the first and second conductor sections 15 and 17 extend alternatingly about their longitudinal axes 16 and 18, but the bridge sections 19 also have an alternating shape about the longitudinal axis 24, here the alternating shape being a square meander. Alternately, the meander may be curved, in a manner not illustrated, or following in some other nonstraight shape.

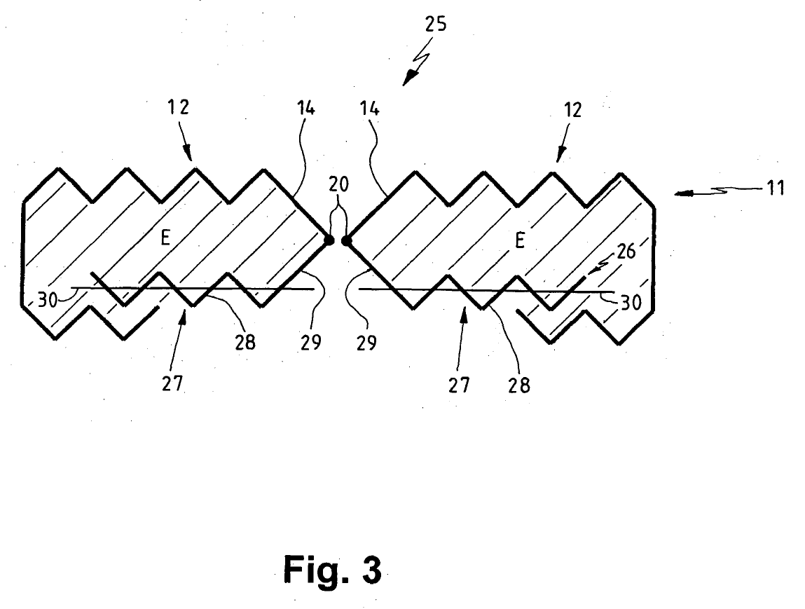

FIG. 3 shows a schematic view of a dual-band dipole antenna 25. In the dual-band dipole antenna 25 a first radiator 11 is formed by two bent-back electrical conductors 12 that are designed for the transmission and reception operation at a low resonant frequency, for example in the 900-MHz mobile communication band. These conductors 12 are as described with reference to FIG. 1.

An additional, second radiator 26 is formed by two additional conductors 27 that are designed, for example, for the mobile communication frequency band of 1800 MHz, that is the second most common in Europe. These conductors are compactly positioned in the conductor planes E defined by the first electrical conductors 12 so that, compared to the illustration in FIG. 1, no additional space is required for providing the additional electrical conductors 27 for the second radiator.

The electrical conductors 27 each have a conductor section 28 that is connected by a respective contact region 29 to a suitable supply line (not illustrated), such as a supply line 21 in FIG. 1, having an HF source of the appropriate frequency.

In the present illustration, the contact regions 29 for the second radiator 26 and the contact regions 14 for the first radiator 11 each form a common contact 20. The conductors 27 for the second radiator 26 are positioned within the conductor plane E defined by the conductors 12 for the first radiator 11. To minimize coupling between the two radiators 11 and 26, that significantly impairs the reception and transmission performance, the conductors 27 are provided at a sufficient spacing away from the conductors 12. The conductors 27 do longitudinally overlap the conductors 17 so that the longitudinal axes 30 of these conductors lies between the axes 16 and 18 and in the same plane E as these axes 16 and 18.

The conductor plane E of the conductors 12 having a low resonant frequency for the respective conductors 28 is advantageously defined for the radiator 26 to enable the radiators 11 and 26 to be compactly interleaved and thus provide the smallest possible design for the dual-band antenna 25. The conductor sections 28 for the second radiator 26 likewise have a zig-zag or meander shape about their longitudinal axis 30 if this is necessary to position them on the conductor plane E.

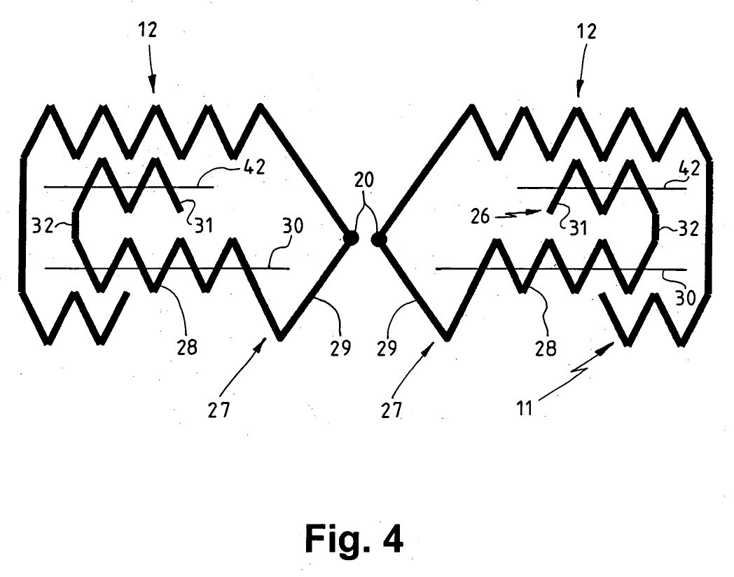

As shown in FIG. 4, the conductors 27 may also have a shape that is bent back in the conductor plane E, so that the conductors 27 for the second radiator 26 have extending from their outer ends second conductor sections 31 next to the first conductor sections 28 and between same and the sections 15. Analogously to the conductors 12, the conductor sections 28 and 31 for the conductors 27 are also separated by bridge sections 32. The second conductor section 31 may be shortened by providing it with an alternating shape along its length 42. Thus, even comparatively long conductors 27 may be positioned in the conductor plane E (not shown in FIG. 4 for the sake of clarity), thereby allowing a compact dual-band dipole antenna to be produced.

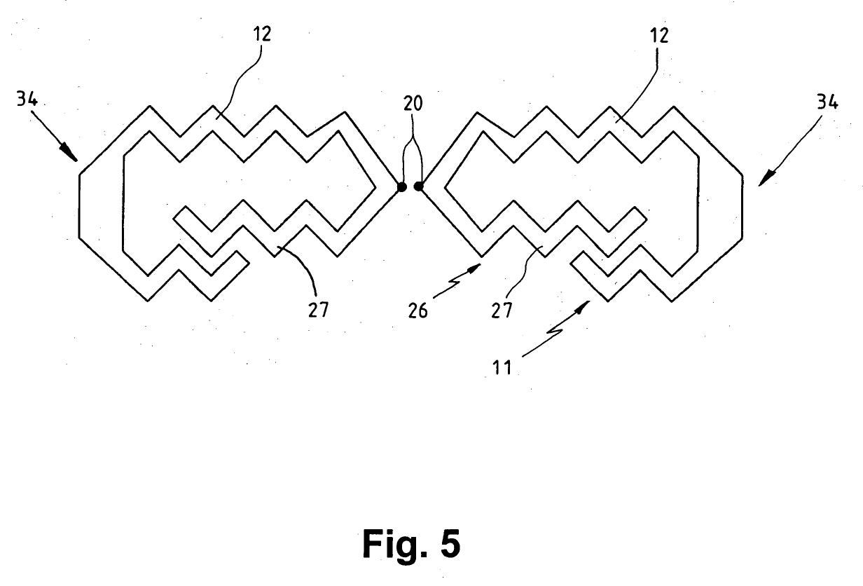

FIG. 5 shows an embodiment of a dual-band dipole antenna 25 according to FIG. 3. The dual-band dipole antenna is characterized in particular by the fact that the conductor structure 34 for the radiators 11 and 26 formed from conductors 12 and 27, is punched from a thin metal sheet or a foil so that it is basically of two-dimensional shape and all its sections are coplanar. The conductor structure 34 has a zigzag, planar shape.

The width of the conductors 12 or 27 does not necessarily have to be constant, as shown in particular at the conductors 12. The conductor structures 34 designed as stamped parts may be manufactured in a particularly simple and economical manner.

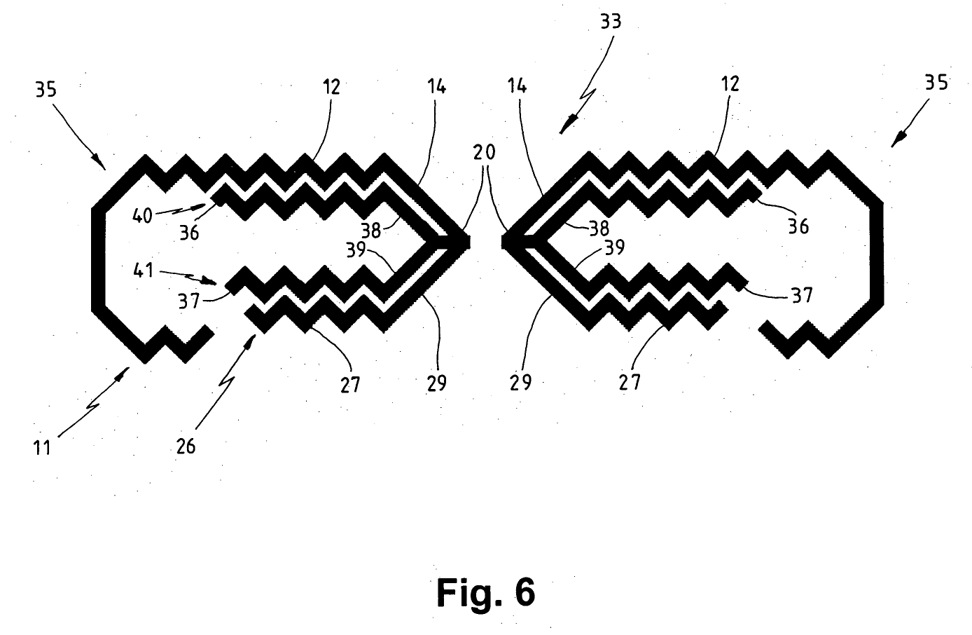

Finally, FIG. 6 shows the manner in which consistent use of the inventive concept illustrated in FIGS. 1 through 5 allows a single- or dual-band dipole antenna to be further developed to produce an extremely compact and efficient multiband dipole antenna 33. With the inventive simplified manufacture, the multiband dipole antenna 33 is composed of two stamped conductor structures 35.

With their respective conductors 12, 27, 36, and 37, the two stamped conductor structures 35 each form a pole comprising radiator 11 having conductor pair 12, radiator 26 having conductor pair 27, radiator 40 having conductor 36, and radiator 41 having conductor 37. Each conductor 12, 27, 36, 37 forms a radiator that is adapted to a specific frequency band. Their contact regions 14, 29, 38, 39 formed by conductors of a stamped part 35 are all joined at a common contact 20 for connection to a suitable HF source, such as the HF source 22 in FIG. 1.

Corresponding to the description for FIGS. 1 and 3, the bent-back conductors 12, that by way of example represent conductors having a low resonant frequency, all lie in a common conductor plane E (see FIGS. 1 and 3), which for the sake of clarity is not illustrated in FIG. 6. The conductors 36, 37, and 27 that are designed for transmission and reception operations at lower resonant frequencies thus all lie in the conductor plane E.

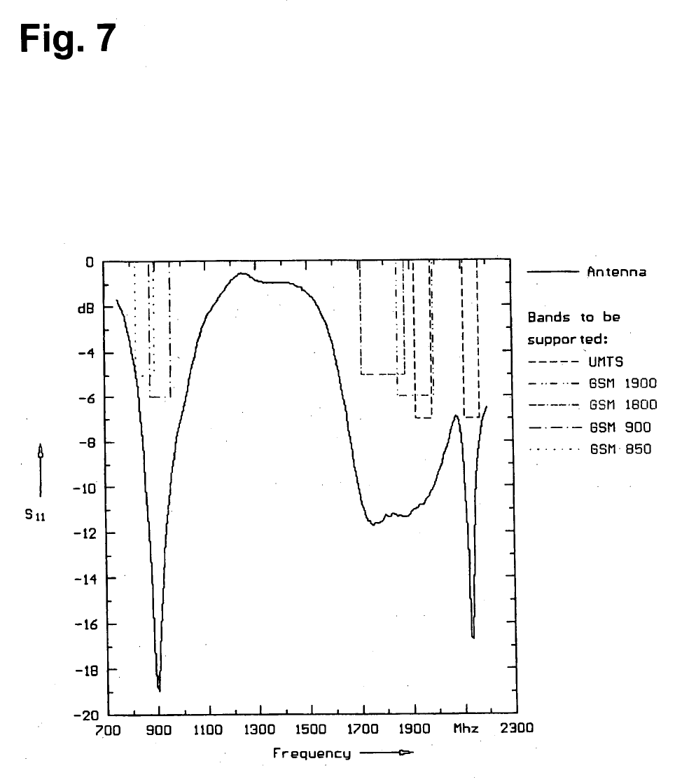

By skillful selection of the respective conductor lengths and appropriate mutual orientation, a dipole antenna designed in this manner can operate, for example, at the most important mobile communication frequencies between 850 and 2200 MHz, namely, GSM 850, 900, 1800, and 1900, and the UNTS frequencies. This is illustrated in FIG. 7 by way of example.

Different and/or additional frequency bands may be covered by changing the conductor lengths and the number of radiators. It is also possible to adapt the multiband dipole antenna to the transmission and/or reception operation in additional frequency bands by means of additional inductive and/or capacitive coupling.

In FIGS. 1 through 6 the individual conductors 12, 27, 36, and 37 basically have a mirror-symmetrical shape with respect to one another. However, this is not absolutely necessary. The shape of the individual conductors 12, 27, 36, and 37 or of the radiators formed by the conductors 12, 27, 36, and 37 depends on the desired reception and transmission characteristics for the antenna.

Not illustrated is a dipole antenna that assumes an even more compact size as the result of further bending.

However, this embodiment may be described, for example, with reference to FIG. 5.

The preferably punched-out conductor structures 34 are significantly shortened compared to the known dipole antennas by virtue of their zig-zag or meander shape and being bent back in their length. Further shortening may be achieved when the conductors (conductors 12 and 27 in FIG. 5) are bent at an angle with respect to the plane of their two-dimensional alternating shape, or at an angle with respect to the stamping plane and thus forming a three-dimensional structure. It is particularly advantageous when this bending likewise has an alternating shape about the longitudinal axis, a zigzag-shaped bend having been proven to be advantageous.

It is also possible to provide the radiators for the dipole antenna with at least one reflector to regulate the transmission and reception performance of the antenna as desired.

Lastly, it is apparent to one skilled in the art that the objects of the invention may also be realized by a monopole antenna (not illustrated) by situating the electrical conductor according to the invention above a base plate.

In summary, it has been-described how compact monopole and dipole antennas may be provided in a simple and advantageous manner by use of the electrical conductor according to the invention, thus allowing transmission and reception operation even at multiple frequency bands.

I claim:

1. A conductor for use as a radiator in an antenna, the conductor having;
a contact section adapted to connect to a high-frequency source;
a first section of alternating shape extending along a first longitudinal axis from an inner end at the contact section to an outer end; and
a second section of alternating shape extending along a second longitudinal axis generally coplanar with and parallel to the first axis from the first-section outer end toward the contact section.

2. The antenna conductor defined in claim 1 wherein the alternating shape is a zigzag or meander.

3. The antenna conductor defined in claim 1 wherein at least one of the first and second sections has a plurality of straight subsections all lying in the plane and mostly extending nonparallel to the respective longitudinal axis.

4. The antenna conductor defined in claim 1 wherein at least one of the first and second sections has subsections not lying in the plane.

5. The antenna conductor defined in claim 1 wherein the sections are formed of printed-circuit traces on a printed-circuit board.

6. The antenna conductor defined in claim 1 wherein the sections are rigid and self-supporting, being anchored at the contacting section.

7. The antenna conductor defined in claim 1 wherein the sections are formed as sheet-metal stampings.

8. The antenna conductor defined in claim 1, further comprising
a bridge section extending transversely between the first-section outer end and an outer end of the second section.

9. The antenna conductor defined in claim 8 wherein the bridge section extends straight in the plane.

10. The antenna conductor defined in claim 8 wherein the bridge section lies in the plane but is of alternating shape centered on a transverse axis lying in the plane.

11. A conductor for use as a radiator in an antenna, the conductor having;
a contact section adapted to connect to a high-frequency source;
a first section of alternating shape extending along a first longitudinal axis from an inner end at the contact section to an outer end;
a second section of alternating shape extending along a second longitudinal axis generally coplanar with and parallel to the first axis from the first-section outer end toward the contact section;
a bridge section extending transversely between the first-section outer end and an outer end of the second section; and
a third section of alternating shape extending along a third longitudinal axis generally coplanar with and parallel to the first and second axes from the contact section and having an is outer end flanked by the first and second sections.

12. The antenna conductor defined in claim 11 wherein the combined longitudinal lengths the second and third sections is greater than that of the first section.

13. A dipole antenna comprising two conductors as defined in claim 11.

14. The dipole antenna defined in claim 13, further comprising:
fourth and fifth sections between and respective adjacent the first and third sections and extending along respective fourth and fifth longitudinal axes generally parallel to and coplanar with the first, second, and third longitudinal axes.

15. The dipole antenna defined in claim 13 wherein the two conductors symmetrically flank a center immediately adjacent and between both contact regions.
